(19) United States
(12) Patent Application Publication
(10) Pub. No.: US 2022/0309720 A1
(43) Pub. Date: Sep. 29, 2022

(54) BOUNDARY LINE VISUALIZATION SYSTEM, BOUNDARY LINE VISUALIZATION METHOD, BOUNDARY LINE VISUALIZATION PROGRAM, AND DIGITAL PHOTO ALBUM CREATION SYSTEM

(71) Applicants: GAKU ASSOCIATES INC., Kanagawa (JP); GOKKO CO. LTD., Tokyo (JP)

(72) Inventors: Manabu Yamada, Kanagawa-shi (JP); Yoshiaki Hashimoto, Tokyo (JP); Hidetoshi Sasaki, Tokyo (JP); Singo Sitara, Tokyo (JP)

(21) Appl. No.: 17/595,072

(22) PCT Filed: Dec. 19, 2019
(86) PCT No.: PCT/JP2019/049840

§ 371 Date: Nov. 8, 2021

(51) Int. Cl. G06T 11/20; G06V 20/10; G06V 20/70; G06V 20/30

(52) U.S. Cl. CPC G06T 11/203; G06V 20/10; G06V 20/70; G06V 20/30

(57) ABSTRACT

A boundary line visualization system having a terminal includes an image acquisition unit configured to acquire an image including a prescribed location, a terminal state acquisition unit configured to acquire a state of the terminal including coordinates and an attitude of the terminal, a boundary line generation unit configured to generate a computer graphics (CG) image based on coordinates of a boundary line present within a certain range from the terminal on the basis of the state of the terminal acquired by the terminal state acquisition unit, and a composite image generation unit configured to generate a composite image in which the CG image of the boundary line is superimposed on the image on the basis of the coordinates indicating the boundary line and the coordinates indicating the prescribed location included in the image acquired by the image acquisition unit.

### TECHNICAL FIELD

The present invention relates to a boundary line visualization system, a boundary line visualization method, a boundary line visualization program, and a digital photo album creation system.

### BACKGROUND ART

In the related art, an augmented reality (AR) providing device that displays images (extended images) representing various types of information about celestial bodies at locations consistent with the celestial bodies in a real space is known (see Patent Literature 1).

Technology described in Patent Literature 1 provides augmented reality (AR) by displaying a computer graphics (CG) image. Also, in the technology described in Patent Literature 1, a field of view of a user (a field of view of AR) is identified (estimated) on the basis of AR location information measured by a measurement unit, direction information acquired by a direction information acquisition unit, attitude information acquired by an attitude information acquisition unit a current timepoint, and the like.

### CITATION LIST

### Patent Literature

### [Patent Literature 1]

Japanese Unexamined Patent Application, First Publication No. 2011-209622

### SUMMARY OF INVENTION

### Technical Problem

Incidentally, according to the technology disclosed in Patent Literature 1, it is difficult to generate and display a CG image of a boundary line.

In view of the above-mentioned problems, an objective of the present invention is to provide a boundary line visualization system, a boundary line visualization method, a boundary line visualization program, and a digital photo album creation system capable of generating a composite image in which a CG image of a boundary line is superimposed on an actual landscape or a video thereof.

### Solution to Problem

According to an aspect of the present invention, there is provided a boundary line visualization system having a terminal, the boundary line visualization system including: an image acquisition unit configured to acquire an image including a prescribed location; a terminal state acquisition unit configured to acquire a state of the terminal including coordinates and an attitude of the terminal; a boundary line generation unit configured to generate a computer graphics (CG) image based on coordinates of a boundary line present within a certain range from the terminal on the basis of the state of the terminal acquired by the terminal state acquisition unit; and a composite image generation unit configured to generate a composite image in which the CG image of the boundary line is superimposed on the image on the basis of the coordinates indicating the boundary line and the coordinates indicating the prescribed location included in the image acquired by the image acquisition unit.

In the boundary line visualization system of the aspect of the present invention, the boundary line may be the International Date Line.

In the boundary line visualization system of the aspect of the present invention, the boundary line may be a line for dividing a ground surface into a plurality of regions in correspondence with a disaster risk level.

According to an aspect of the present invention, there is provided a boundary line visualization method including: an image acquisition step of acquiring an image including a prescribed location; a terminal state acquisition step of acquiring a state of a terminal including coordinates and an attitude of the terminal; a boundary line generation step of generating a CG image based on coordinates of a boundary line present within a certain range from the terminal on the basis of the state of the terminal acquired in the terminal state acquisition step; and a composite image generation step of generating a composite image in which the CG image of the boundary line is superimposed on the image on the basis of the coordinates indicating the boundary line and the coordinates indicating the prescribed location included in the image acquired in the image acquisition step.

According to an aspect of the present invention, there is provided a boundary line visualization program for causing a computer to execute: an image acquisition step of acquiring an image including a prescribed location; a terminal state acquisition step of acquiring a state of a terminal including coordinates and an attitude of the terminal; a boundary line generation step of generating a CG image based on coordinates of a boundary line present within a certain range from the terminal on the basis of the state of the terminal acquired in the terminal state acquisition step; and a composite image generation step of generating a composite image in which the CG image of the boundary line is superimposed on the image on the basis of the coordinates indicating the boundary line and the coordinates indicating the prescribed location included in the image acquired in the image acquisition step.

According to an aspect of the present invention, there is provided a digital photo album creation system having a terminal, the digital photo album creation system including: an image acquisition unit configured to acquire an image including a prescribed location; a terminal state acquisition unit configured to acquire a state of the terminal including coordinates and an attitude of the terminal; a boundary line generation unit configured to generate a CG image based on coordinates of a boundary line present within a certain range from the terminal on the basis of the state of the terminal acquired by the terminal state acquisition unit; and a composite image generation unit configured to generate a composite image in which the CG image of the boundary line is superimposed on the image on the basis of the coordinates indicating the boundary line and the coordinates indicating the prescribed location included in the image acquired by the image acquisition unit.

### Advantageous Effects of Invention

According to the present invention, it is possible to provide a boundary line visualization system, a boundary line visualization method, a boundary line visualization program, and a digital photo album creation system capable of generating a composite image in which a CG image of a boundary line is superimposed.

### BRIEF DESCRIPTION OF DRAWINGS

FIG. 1 is a diagram showing an example of an overview of a boundary line visualization system of a first embodiment.

FIG. 2A is a diagram showing a first example of a composite image generated by a composite image generation unit of a terminal.

FIG. 2B is a diagram showing a second example of a composite image generated by the composite image generation unit of the terminal.

FIG. 2C is a diagram showing a third example of a composite image generated by the composite image generation unit of the terminal.

FIG. 3 is a sequence diagram for describing an example of a process executed in the boundary line visualization system of the first embodiment.

FIG. 4 is a diagram showing an example of the application of the boundary line visualization system of the first embodiment.

FIG. 5 is a diagram showing an example of an overview of a boundary line visualization system of a second embodiment.

FIG. 6 is a sequence diagram for describing an example of a process executed in the boundary line visualization system of the second embodiment.

FIG. 7 is a diagram showing an example of an overview of a boundary line visualization system of a third embodiment.

### DESCRIPTION OF EMBODIMENTS

Hereinafter, embodiments of a boundary line visualization system, a boundary line visualization method, a boundary line visualization program, and a digital photo album creation system of the present invention will be described.

### First Embodiment

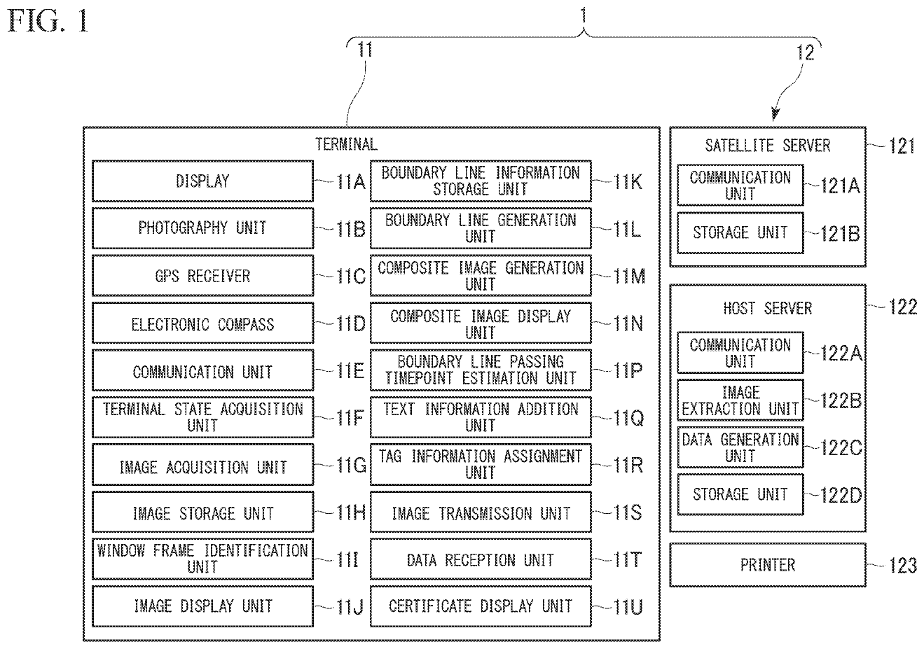

FIG. 1 is a diagram showing an example of an overview of a boundary line visualization system 1 of a first embodiment.

In the example shown in FIG. 1, the boundary line visualization system 1 includes a terminal 11 and a server system 12.

The terminal 11 is, for example, a portable phone, a smartphone, a tablet terminal, or the like. The terminal 11 includes, for example, a display 11A, a photography unit 11B, a Global Positioning System (GPS) receiver 11C, an electronic compass 11D, and a communication unit 11E as hardware.

The display 11A is a display screen such as a liquid crystal panel. The photography unit 11B is, for example, a camera that captures an image or the like. The GPS receiver 11C receives radio waves from GPS satellites. The electronic compass 11D detects a direction by observing geomagnetism or the like. The communication unit 11E communicates with the server system 12 or the like via, for example, the Internet or the like. That is, the terminal 11 has a communication function.

The terminal 11 includes a boundary line visualization application that operates on hardware. That is, the boundary line visualization application is installed as software that operates on the hardware in the terminal 11.

As the boundary line visualization application, the terminal 11 includes a terminal state acquisition unit 11F, an image acquisition unit 11G, an image storage unit 11H, a window frame identification unit 11I, an image display unit 11J, a boundary line information storage unit 11K, a boundary line generation unit 11L, a composite image generation unit 11M, a composite image display unit 11N, a boundary line passing timepoint estimation unit 11P, a text information addition unit 11Q, a tag information assignment unit 11R, an image transmission unit 11S, a data reception unit 11T, and a certificate display unit 11U.

The terminal state acquisition unit 11F acquires a state of the terminal 11 including coordinates and an attitude of the terminal 11. Specifically, the terminal state acquisition unit 11F calculates the coordinates (latitude, longitude, and altitude) of the terminal 11 on the basis of the radio waves received by the GPS receiver 11C and acquires the calculated coordinates of the terminal 11 as the state of the terminal 11. Also, the terminal state acquisition unit 11F calculates the attitude of the terminal 11 on the basis of a direction of the terminal 11 detected by the electronic compass 11D and the like and acquires the calculated attitude of the terminal 11 as the state of the terminal 11.

The image acquisition unit 11G acquires an image IM (for example, a still image or a moving image) including a prescribed location. The “prescribed location” is a location where the coordinates indicating the location are recognized in advance by the terminal 11. The image acquisition unit 11G acquires, for example, the image IM including scenery photographed by the photography unit 11B. Also, the image acquisition unit 11G can also acquire the image IM delivered by, for example, the server system 12.

The image storage unit 11H stores the image IM acquired by the image acquisition unit 11G.

The window frame identification unit 11I identifies a window frame WF, for example, when the image IM acquired by the image acquisition unit 11G includes the window frame WF (i.e., identifies where the window frame WF is in the image IM). A type of window frame capable of being identified by the window frame identification unit 11I of the first embodiment is not particularly limited and examples of the window frame include a window frame of a guest room of an aircraft or a ship. For example, a prescribed marker is attached to the window frame WF so that the window frame identification unit 11I can identify the window frame WF. In another example, the window frame identification unit 11I may identify the window frame WF included in the image IM acquired by the image acquisition unit 11G by collating the image IM including the window frame WF acquired by the image acquisition unit 11G with an image database of the window frame that has been created in advance. In yet another example, machine learning of the window frame identification unit 11I may be performed or other known technologies may be applied so that the window frame identification unit 11I can identify the window frame WF.

The image display unit 11J displays the image IM acquired by the image acquisition unit 11G. Specifically, the image display unit 11J causes the image IM to be displayed on the display 11A.

The boundary line information storage unit 11K stores information about a boundary line BL, which is a target of visualization by the boundary line visualization system 1 of the first embodiment. For example, the boundary line information storage unit 11K stores information about coordinates such as latitude and longitude indicating the boundary line BL. In the boundary line visualization system 1 of the first embodiment, the boundary line information storage unit 11K may store, for example, information about coordinates indicating the International Date Line, the Greenwich Meridian, the International Earth Rotation and Reference Systems Service (IERS) Reference Meridian, the equator, a national border, or the like as information about the boundary line BL. In the following example, the International Date Line will be described as an example of the boundary line BL.

The boundary line generation unit 11L generates a computer graphics (CG) image based on the coordinates of the boundary line BL present within a certain range from the terminal 11 on the basis of the state of the terminal 11 acquired by the terminal state acquisition unit 11F. For example, the CG image generated by the boundary line generation unit 11L is a linear image for reproducing a shape of the boundary line BL by passing these coordinates from a plurality of coordinates for identifying the boundary line BL.

Also, the boundary line generation unit 11L may be configured to be able to assign a pattern image for decoration and effect information in addition to the image for reproducing the shape of the boundary line BL. For example, the boundary line generation unit 11L may generate an image of a decorative pattern that is recognized by the user like a wall rising vertically from the location of the boundary line BL, a video having an effect in which a curtain shape extending along the boundary line sways at regular intervals or randomly, or the like for the sake of decoration. Also, the boundary line generation unit 11L may detect a surface (a flat surface such as a ground surface, a protrusion, a depression, or the like) at the location of the boundary line BL in the image acquired by the image acquisition unit 11G and correct (process) a CG image along the surface.

The composite image generation unit 11M generates a composite image CM in which the CG image of the boundary line BL is superimposed on the image IM on the basis of coordinates indicating the prescribed location included in the image IM acquired by the image acquisition unit 11G and coordinates indicating the boundary line BL. For example, when the image acquisition unit 11G has acquired an image IM including the scenery photographed by the terminal 11, the composite image generation unit 11M generates a composite image CM in which the CG image of the boundary line BL is superimposed on the image IM including the scenery.

The composite image display unit 11N displays the composite image CM generated by the composite image generation unit 11M. Specifically, the composite image display unit 11N causes the composite image CM to be displayed on the display 11A.

The boundary line passing timepoint estimation unit 11P estimates a timepoint at which the terminal 11 will pass the boundary line BL on the basis of the coordinates of the terminal 11 acquired by the terminal state acquisition unit 11F and the coordinates indicating the boundary line BL stored in the boundary line information storage unit 11K. Specifically, the boundary line passing timepoint estimation unit 11P calculates a current location (coordinates at the current timepoint), a speed, a direction, or the like of the terminal 11 on the basis of coordinates of the terminal 11 at a plurality of timepoints acquired by the terminal state acquisition unit 11F. Further, the boundary line passing timepoint estimation unit 11P calculates (estimates) a timepoint at which the terminal 11 will pass the boundary line BL on the basis of the calculated current location (the coordinates at the current timepoint), speed, direction, or the like of the terminal 11, and the coordinates indicating the boundary line BL.

The text information addition unit 11Q adds text information indicating the timepoint at which the terminal 11 will pass the boundary line BL estimated by the boundary line passing timepoint estimation unit 11P to the composite image CM generated by the composite image generation unit 11M. The text information addition unit 11Q adds text information such as, for example, “crossing the International Date Line in OO minutes and OO seconds” to the composite image CM. When the text information indicating the timepoint when the terminal 11 will pass the boundary line BL has been added, the composite image display unit 1IN displays the composite image CM to which the text information indicating the timepoint when the terminal 11 will pass the boundary line BL is added.

When the composite image CM generated by the composite image generation unit 11M includes the boundary line BL, the tag information assignment unit 11R assigns tag information indicating that the composite image CM includes the boundary line BL to the data of the composite image CM. The tag information assigned by the tag information assignment unit 11R of the first embodiment is information for distinguishing between before and immediately after the terminal 11 passes the boundary line BL.

The image transmission unit 11S transmits the composite image CM generated by the composite image generation unit 11M to the server system 12 or the like. As will be described below, the server system 12 has a function of generating a passing certificate for certifying that the terminal 11 has passed the International Date Line or the like.

The data reception unit 11T receives the data of the passing certificate generated in the server system 12 or the like. The certificate display unit 11U displays the passing certificate or the like on the basis of the passing certificate data or the like received by the data reception unit 11T. Specifically, the certificate display unit 11U causes the display 11A to display the passing certificate or the like.

The server system 12 manages (stores or keeps) the composite image CM (for example, a still image or a moving image) transmitted from the terminal 11 or the like. When a plurality of composite images CM are transmitted from a plurality of terminals 11 and the like to the server system 12, the server system 12 manages (stores or keeps) the plurality of composite images CM transmitted from the plurality of terminals 11 and the like for each terminal. The server system 12 includes a satellite server 121, a host server 122, and a printer 123.

The satellite server 121 is installed within, for example, an aircraft. The satellite server 121 includes a communication unit 121A and a storage unit 121B. The communication unit 121A performs, for example, communication with the terminal 11 located within the aircraft, communication with the host server 122 during the flight or parking of the aircraft, communication with the printer 123, and the like. Specifically, the communication unit 121A receives, for example, a composite image CM and the like transmitted by the image transmission unit 11S of the terminal 11 during the flight of an aircraft. The storage unit 121B temporarily stores, for example, the composite image CM and the like received by the communication unit 121A, For example, after the landing of the aircraft, the communication unit 121A transfers the composite image CM or the like stored in the storage unit 121B to the host server 122. the printer 123, or the like. Also, the communication unit 121A may communicate with the host server 122 or the printer 123 during the flight of the aircraft in accordance with a capacity of a wireless communication circuit between the aircraft and the ground during the flight.

The host server 122 is installed on, for example, the ground. The host server 122 includes a communication unit 122A, an image extraction unit 122B, a data generation unit 122C, and a storage unit 122D.

The communication unit 122A performs, for example, communication with the terminal 11 located on the ground, communication with the satellite server 121 during the flight or parking of the aircraft, communication with the printer 123 and other devices after the landing of the aircraft and the like. Specifically, the communication unit 122A receives, for example, a composite image CM transmitted by the communication unit 121A of the satellite server 121 or the like after the landing of the aircraft.

The image extraction unit 122B extracts a composite image CM including the tag information assigned by the tag information assignment unit 11R of the terminal 11 (i.e., the tag information indicating that the boundary line BL is included in the composite image CM) from, for example, among a plurality of composite images CM received by the communication unit 122,E after the landing of the aircraft.

The data generation unit 122C generates passing certificate data for certificating that the terminal 11 or the like has passed the boundary line BL and the like on the basis of the composite image CM including the tag information extracted by the image extraction unit 122B (i.e., on the basis of the tag information assigned to the data of the composite image CM). The passing certificate data generated by the data generation unit 122C includes a date and time when the terminal 11 or the like passed the boundary line BL, a flight number of an aircraft, a name of a captain, a signature of the captain, and the like.

The storage unit 122D stores the passing certificate data generated by the data generation unit 122C.

The communication unit 122A can transmit the passing certificate data generated by the data generation unit 122C to the printer 123.

The printer 123 is installed within, for example, an airport or an aircraft. After the landing of the aircraft, for example, when the printer 123 installed at the airport has received the passing certificate data transmitted by the communication unit 122A of the host server 122, the printer 123 prints the passing certificate. The passing certificate printed by the printer 123 is presented to the user of the terminal 11 using the aircraft.

The communication unit 122A can transmit the passing certificate data generated by the data generation unit 122C to the terminal 11.

After the landing of the aircraft, when the terminal 11 has received the passing certificate data transmitted by the communication unit 122.A of the host server 122, for example, the image storage unit 11H of the terminal 11 stores the passing certificate data, and the certificate display unit 11U of the terminal 11 displays the passing certificate.

If there is a sufficient wireless communication line capacity available during the flight of the aircraft, the communication unit 122A may transmit the passing certificate data to the terminal 11 during the flight of the aircraft via the satellite server 121 or through an Internet network. In this case, the passing certificate can be displayed during the flight of the aircraft. Further, when the printer 123 is installed within the aircraft, a printed passing certificate can be presented to the user within the aircraft.

The user of the terminal 11 can download the passing certificate data stored in the storage unit 122D of the host server 122 or use the passing certificate data stored in, for example, the image storage unit 11H of the terminal 11, so that it is possible to cause, for example, a printer at home (not shown), a printer at a specialty store (not shown), or the like, to print the passing certificate. When the passing certificate data stored in the storage unit 122D of the host server 122 is downloaded, a reference number and the like required for downloading the passing certificate data are issued from the host server 122 to the boundary line visualization application of the terminal 11.

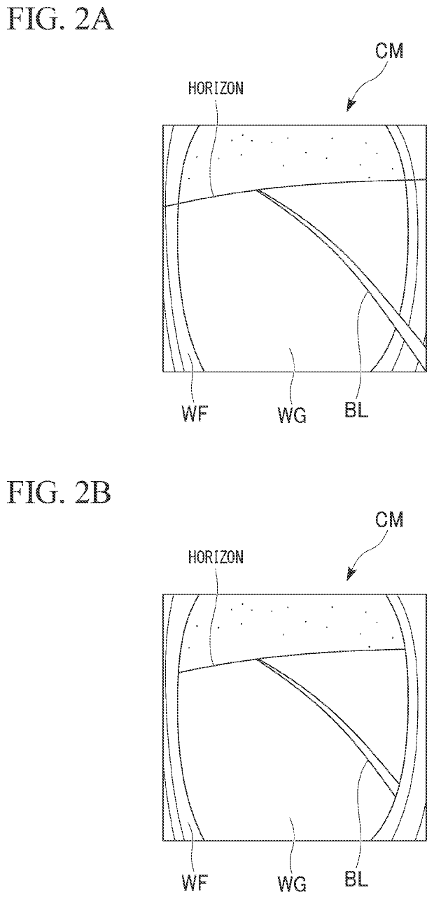

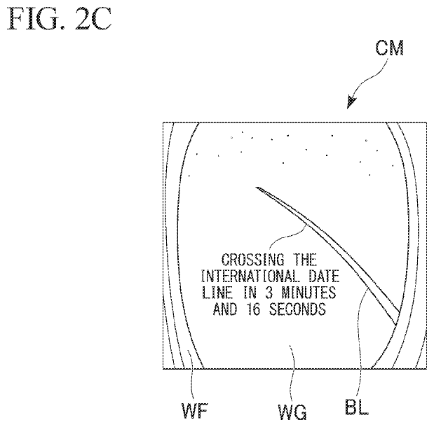

FIG. 2A is a diagram showing a first example of a composite image CM generated by the composite image generation unit 11M of the terminal 11. FIG. 2B is a diagram showing a second example of the composite image CM generated by the composite image generation unit 11M of the terminal 11. FIG. 2C is a diagram showing a third example of the composite image CM generated by the composite image generation unit 11M of the terminal 11.

In the example shown in FIGS. 2A, 2B, and 2C, the photography unit 11B of the terminal 11 captures an image IM including outside scenery from inside of a room having a window through the window. Specifically, the photography unit 11B captures an image IM including scenery outside the aircraft from inside of the aircraft through a window glass WG of the aircraft. The image acquisition unit 11G of the terminal 11 acquires the image IM including the scenery outside the aircraft photographed by the photography unit 11B. The terminal state acquisition unit 11F of the terminal 11 acquires the state of the terminal 11 including coordinates and an attitude of the terminal 11 at the time of capturing the image IM including the scenery outside the aircraft.

The boundary line generation unit 11L of the terminal 11 generates a CG image of the International Date Line present within a certain range from the terminal 11 as a CG image of the boundary line BL on the basis of the state of the terminal 11 acquired by the terminal state acquisition unit 11F. Specifically, the boundary line generation unit 11L generates a CG image in which a portion of the boundary line BL present within the certain range from the terminal 11 is set as a display target. The composite image generation unit 11M of the terminal 11 generates a composite image CM in which the CG image of the boundary line BL is superimposed on the image IM including the outside scenery photographed by the photography unit 11B. Specifically, the composite image generation unit 11M generates a composite image CM in which a CG image of the boundary line BL (the International Date Line) is superimposed on the image IM on the basis of coordinates indicating a prescribed location included in the image IM including the scenery outside the aircraft acquired by the image acquisition unit 11G and coordinates indicating the boundary line BL (the International Date Line).

Specifically, in the first example shown in FIG. 2A, the composite image generation unit 11M causes the CG image of the boundary line BL (the International Date Line) to be superimposed on the image IM including the scenery outside the aircraft so that the CG image of the boundary line BL (the International Date Line) has a linear shape which is thinner when the boundary line BL is farther from the terminal 11 (i.e., when the boundary line BL is farther from the window glass WG of the aircraft) and disappears on the horizon.

In the first example shown in FIG. 2A, the CG image of the boundary line BL (the International Date Line) generated by the boundary line generation unit 11L becomes a three-dimensional CG image including curves along the ground surface as a whole as a set of straight lines connecting a plurality of coordinates.

In the second example shown in FIG. 2B, the window frame identification unit 11I of the terminal 11 identifies where the window frame WF is in the image IM including the scenery outside the aircraft. Further, the composite image generation unit 11M processes (for example, trims) the CG image of the boundary line BL (the International Date Line) and causes the processed CG image to be superimposed on the image IM including the scenery outside the aircraft so that the CG image of the boundary lime BL (the International Date Line) is located only inside the window frame WF identified by the window frame identification unit 11I.

In the second example shown in FIG. 2B, the user of the boundary line visualization system 1 is able to have a simulated experience of visually observing the boundary line BL (the International Date Line) from inside of the aircraft through the window glass WG of the aircraft.

In the third example shown in FIG. 2C, the boundary line passing timepoint estimation unit 11P of the terminal 11 estimates a timepoint at which the terminal 11 will pass the boundary line BL (the International Date Line) on the basis of the coordinates of the terminal 11 acquired by the terminal state acquisition unit 11F and the coordinates indicating the boundary line BL (the International Date Line) stored in the boundary line information storage unit 11K. Further, the text information addition unit 11Q of the terminal 11 adds text information indicating the timepoint which the terminal 11 will pass the boundary line BL (the International Date Line) estimated by the boundary line passing timepoint estimation unit 11P to the composite image CM generated by the composite image generation unit 11M.

In the third example shown in FIG. 2C, the composite image generation unit 11M generates a composite image CM to which text information for reminding the user of a locational relationship with the boundary line BL or a change in the locational relationship such as “crossing the International Date Line in 3 minutes and 16 seconds” is added by the text information addition unit 11Q and the composite image display unit 11N displays the composite image CM generated by the composite image generation unit 11M.

In another example, the terminal state acquisition unit 11F detects that the terminal 11 has passed the boundary line BL (the International Date Line) on the basis of radio waves received by the GPS receiver 11C. Using this as a trigger, the composite image generation unit 11M may generate a composite image CM to which text information indicating that the terminal 11 has passed the boundary line BL such as “Crossed the International Date Line at ΔΔ (hour):ΔΔ (minute):ΔΔ (second)” is added by the text information addition unit 11Q and the composite image display unit 11N may display the composite image CM generated by the composite image generation unit 11M.

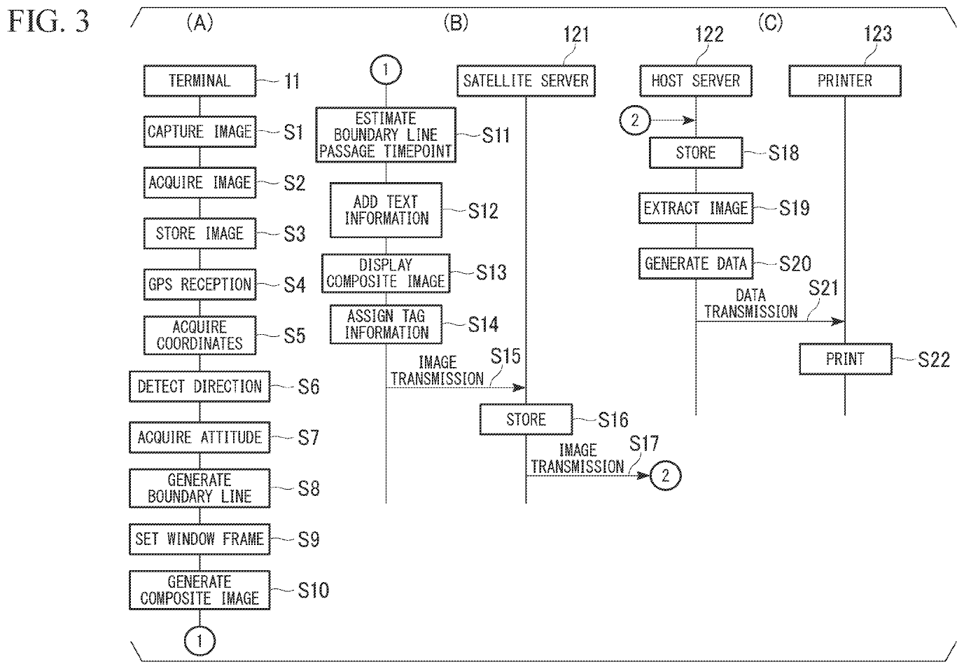

FIG. 3 is a sequence diagram for describing an example of a process executed in the boundary line visualization system 1 of the first embodiment.

In the example shown in FIG. 3, in step S1 executed during the flight of the aircraft, the photography unit 11B of the terminal 11 captures an image IM including the scenery outside the aircraft from inside of the aircraft through the window glass WG of the aircraft. The image IM including the scenery outside the aircraft includes a prescribed location and coordinates indicating the prescribed location are recognized in advance by the terminal 11.

Subsequently, in step S2, the image acquisition unit 11G of the terminal 11 acquires the image IM including the scenery outside the aircraft captured in step S1.

Subsequently, in step S3, the image storage unit 11H of the terminal 11 stores the image IM including the scenery outside the aircraft acquired in step S2.

Also, in step S4, the GPS receiver 11C of the terminal 11 receives the radio waves from the GPS satellites.

Subsequently, in step S5, the terminal state acquisition unit 11F of the terminal 11 calculates coordinates of the terminal 11 on the basis of the radio waves received in step S4, and acquires the calculated coordinates of the terminal 11 as a state of the terminal 11.

Also, in step S6, the electronic compass 11D of the terminal 11 detects a direction (a direction of the terminal 11) by observing geomagnetism or the like.

Subsequently, in step S7, the terminal state acquisition unit 11F of the terminal 11 calculates an attitude of the terminal 11 on the basis of the direction of the terminal 11 detected in step S6 and the like and acquires the calculated attitude of the terminal 11 as the state of the terminal 11.

Subsequently, in step S8, the boundary line generation unit 11L of the terminal 11 generates a CG image based on the coordinates of the boundary line BL present within a certain range from the terminal 11 on the basis of the state of the terminal 11 acquired in steps S5 and S7 and information necessary for generating the CG image of the boundary line BL (the International Date Line) stored in the boundary line information storage unit 11K.

Subsequently, in step S9, the window frame identification unit 11I of the terminal 11 determines whether or not the window frame WF is included in the image IM including the scenery outside the aircraft acquired in step S2 and identifies where the window frame WF is in the image IM including the scenery outside the aircraft when the window frame WF is included in the image IM including the scenery outside the aircraft.

Subsequently, in step S10, the composite image generation unit 11M of the terminal 11 generates a composite image CM in which the CG image of the boundary line BL is superimposed on the image IM on the basis of the coordinates indicating the prescribed location included in the image IM including the scenery outside the aircraft acquired in step S2 and the coordinates indicating the boundary line BL (the International Date Line) stored in the boundary line information storage unit 11K of the terminal 11.

Subsequently, in step S11, the boundary line passing timepoint estimation unit 11P of the terminal 11 estimates a timepoint at which the terminal 11 will pass the boundary line BL (the International Date Line) on the basis of the coordinates of the terminal 11 acquired in step S5 and the coordinates indicating the boundary line BL (the International Date Line) stored in the boundary line information storage unit 11K.

Subsequently, in step S12, the text information addition unit 11Q of the terminal 11 adds the text information indicating the timepoint at which the terminal 11 will pass the boundary line BL (the International Date Line) estimated in step S11 to the composite image CM generated in step S10.

Subsequently, in step S13, the composite image display unit 11N of the terminal 11 displays the composite image CM generated in step S10 to which the text information has been added in step S12.

Subsequently, in step S14, the tag information assignment unit 11R of the terminal 11 determines whether or not the composite image CM generated in step S10 includes the International Date Line as the boundary line BL and assigns tag information indicating that the composite image CM includes the International Date Line to data of the composite image CM when the composite image CM includes the International Date Line as the boundary line BL. The tag information assigned in step S14 includes information for distinguishing between before the terminal 11 passes the International Date Line and immediately after the terminal 11 passes the International Date Line.

Subsequently, in step S15, the image transmission unit 11S of the terminal 11 transmits the composite image CM generated in step S10 to which the text information has been added in step S12 to the satellite server 121 of the server system 12. Specifically, the data of the composite image CM transmitted in step S15 includes the tag information assigned in step S14.

Subsequently, in step S16, the storage unit 121B of the satellite server 121 stores the composite image CM transmitted in step S15. Specifically, the composite image CM data stored in step S16 includes the tag information assigned in step S14.

Subsequently, in step S17 executed after the landing of the aircraft, the communication unit 121A of the satellite server 121 transfers the composite image CM stored in step S16 to the host server 122 of the server system 12.

Subsequently, in step S18, the storage unit 122D of the host server 122 stores the composite image CM transferred in step S17. Specifically, data of the composite image CM stored in step S18 includes the tag information assigned in step S14.

Subsequently, in step S19, the image extraction unit 122B of the host server 122 extracts the composite image CM immediately after the terminal 11 passes the International Date Line using the tag information assigned in step S14 from among the plurality of composite images CM received by the communication unit 122A of the host server 122 after the landing of the aircraft. Also, when the composite image CM is not a composite image CM to which tag information indicating the time immediately after the terminal 11 passes the International Date Line is assigned, an image is extracted in a prescribed procedure (for example, with reference to a timestamp) from the composite image CM including the tag information.

Subsequently, in step S20, the data generation unit 122C of the host server 122 generates passing certificate data for certifying that the terminal 11 has passed the International Date Line on the basis of the composite image CM including the tag information extracted in step S19 (i.e., on the basis of the tag information assigned to the data of the composite image CM). The passing certificate data generated in step S20 includes a date and time when the terminal 11 passed the International Date Line, a flight number of the aircraft, a name of a captain, a signature of the captain, and the like.

Subsequently, in step S21, the communication unit 122A of the host server 122 transmits the passing certificate data generated in step S20 to the printer 123 of the server system 12.

Subsequently, in step S22, the printer 123 prints the passing certificate on the basis of the passing certificate data transmitted in step S21. The passing certificate printed in step S22 is presented to the user of the terminal 11 using the aircraft.

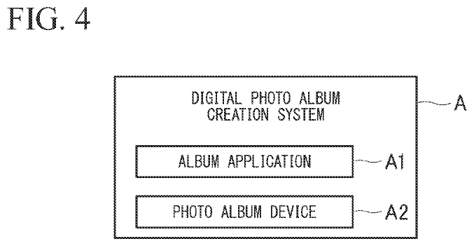

FIG. 4 is a diagram showing an example of the application of the boundary line visualization system 1 of the first embodiment.

In the example shown in FIG. 4, the boundary line visualization system 1 is applied to the digital photo album creation system A. The digital photo album creation system A includes an album application A1 installed in the terminal 11 and a photo album device A2.

The album application A1 can acquire a CG image CM including the boundary line BL in cooperation with the boundary line visualization application of the boundary line visualization system 1 or by including the boundary line visualization application in a part of the program.

The photo album device A2 has a function of displaying and printing a composite image CM and other images generated by the composite image generation unit 114 of the terminal 11, a function of printing a passing certificate on the basis of passing certificate data generated by the data generation unit 122C of the host server 122, and the like. Also, the photo album device A2 has a function of creating a photo alb un by binding a printed matter or the like.

That is, the digital photo album creation system A shown in FIG. 4 includes the boundary line visualization application (the album application A1) installed in the terminal 11 having a communication function, and the server system 12 capable of communicating with the terminal 11.

The boundary line visualization application, which operates on the hardware of the terminal 11, has uniquely identifiable identification (ID) information and can communicate with the server system 12. Also, the boundary line visualization application can access the photography unit 11B (the camera) of the terminal 11 and the image acquisition unit 11G of the boundary line visualization application acquires a moving image and a still image captured by the photography unit 11B. The image storage unit 11H of the boundary line visualization application saves (stores) moving images and still images acquired by the image acquisition unit 11G.

When the photography unit 11B captures a moving image and a still image while the boundary line visualization application is being activated, the image acquisition unit 11G acquires the moving image and the still image captured by the photography unit 11B.

When the moving image and the still image are delivered by the server system 12, the image acquisition unit 11G acquires the moving image and the still image delivered by the server system 12.

The image display unit 11J of the boundary line visualization application can organize and display files of moving and still images on the basis of dates such as an acquisition date and a delivery date of the moving and still images.

The image transmission unit 11S of the boundary line visualization application can transmit a moving image and a still image acquired by the image acquisition unit 11G, a composite image CM generated by the composite image generation unit 11M, and the like to any photo album device A2 designated by a user of the digital photo album creation system A.

The server system 12 includes the satellite server 121 installed in each aircraft to save data transmitted from the terminal 11 within the aircraft and the host server 122 installed on the ground capable of transmitting and receiving data to and from the satellite server 121.

The server system 12 manages (stores or keeps) moving images and still images transmitted from each terminal in which the boundary line visualization application is installed for each terminal. As described above, the storage unit 121B of the satellite server 121 installed within the aircraft temporarily saves the composite image CM (a composite image in which the CG image of the boundary line BL is superimposed on the moving image, the still image, or the like). After the landing of the aircraft, the communication unit 121A of the satellite server 121 transfers all data of the composite image CM and the like to the host server 122 on the ground via the Internet or the like.

The host server 122 is connected to a plurality of terminals in which the boundary line visualization application is installed, personal computers around the world, and the like via the Internet or the like so that the host server 122 can be accessed. The terminal 11 in which the boundary line visualization application is installed can transmit various types of data (for example, data of an image captured by the photography unit 11B, data of an image acquired by the image acquisition unit 11G, data of a CG image generated by the boundary line generation unit 11L, data of a composite image CM generated by the composite image generation unit 11M, tag information assigned by the tag information assignment unit 11R, and the like) to the host server 122. Also, the terminal 11 in which the boundary line visualization application is installed can receive various types of data (for example, passing certificate data) from the host server 122.

When a communication circuit of the wireless communication service (for example, a communication circuit of Wi-Fi (trademark)) within the aircraft has a large capacity and a high speed and can be used stably, the terminal 11 located within the aircraft can perform communication with the host server 122 in real time via the wireless communication service within the aircraft.

The server system 12 can transmit data of the above-described images and the like to any photo album device A2 designated by the user of the digital photo album creation system A.

In the first example of the digital photo album creation system A, when the terminal 11 is located near prescribed coordinates, the boundary line visualization application can execute content corresponding to the coordinates. For example, when the terminal 11 is located near coordinates indicating the boundary line BL (the International Date Line), the boundary line visualization application executes the content corresponding to the coordinates (for example, content for generating a composite image CM in which the composite image CG of the boundary line BL (the International Date Line) is superimposed on a landscape image or the like).

For example, the boundary line visualization application causes the display 11A of the terminal 11 to display a notification for prompting the user of the terminal 11 to activate the boundary line visualization application when the terminal 11 enters a certain range from the coordinates indicating the boundary line BL (the International Date Line) as a trigger.

In the second example of the digital photo album creation system A, a display screen on the display 11A of the terminal 11 transitions to a display screen associated with the boundary line BL (the International Date Line) when the terminal 11 enters a certain range from the coordinates indicating the boundary line BL (the International Date Line) as a trigger while the boundary line visualization application is being activated. As a result, the boundary line visualization application can prompt the user of the terminal 11 to perform a browsing process, an operation, or the like associated with the boundary line BL (the International Date Line).

The user of the terminal 11 cannot see the boundary line BL (the International Date Line) with the naked eye. When the user of the terminal 11 causes the terminal 11 to be located in a direction in which the boundary line BL (the International Date Line) is considered to be present, the CG image of the boundary line BL (the International Date Line) generated by the boundary line generation unit 11L of the terminal 11 is superimposed on the image IM acquired by the image acquisition unit 11G of the terminal 11 (for example, the image IM during a photography process of the photography unit 11B) and displayed as a composite image CM on the display 11A of the terminal 11.

That is, the boundary line visualization application generates a CG image of the International Date Line in correspondence with a location and an attitude of the terminal 11 using the coordinates of the terminal 11 (latitude, longitude, and altitude acquired from a GPS device) and coordinates (latitude and longitude) for identifying the International Date Line within a certain range from the terminal 11 and displays the generated CG image superimposed on a moving image or a still image during photography. The CG image of the International Date Line is displayed as a line connecting the coordinates that define the International Date Line. Also, the boundary line visualization application can capture (record) a moving image or a still image including a CG image of the International Date Line. The moving image or the still image including the CG image of the International Date Line is saved in the boundary line visualization application (for example, in the image storage unit 11H). The user of the terminal 11 can also take a selfie using a front camera.

The boundary line visualization application can transmit a composite image CM including the International Date Line to the server system 12. Tag information indicating that the composite image CM includes the International Date Line is assigned to the data of the composite image CM transmitted to the server system 12 by the tag information assignment unit 11R.

A certain upper limit may be set for the number of images that include tag information to be transmitted (for example, “up to two still images”).

The boundary line visualization application can also transmit a moving or still image other than an image including the International Date Line to the server system 12 (the user of the boundary line visualization system 1 can freely use a moving or still image transmitted to the server system 12 by the boundary line visualization application as a backup or a material for the creation of paper albums.).

The server system 12 (the image extraction unit 122B of the host server 122) automatically extracts an image including tag information indicating that the International Date Line is included from the images transmitted from the terminal 11. The server system 12 (the data generation unit 122C of the host server 122) generates digital data of a printable format including at least one of the date and time when the terminal 11 passed the International Date Line, a flight number of an aircraft, and a name of a captain (a signature of the captain) of the aircraft.

The server system 12 (the storage unit 122D of the host server 122) keeps (stores) digital data of a passing certificate so that the digital data can be downloaded to the boundary visualization application.

Also, the server system 12 (the communication unit 122A of the host server 122) transmits the digital data to the boundary visualization application in response to a request of the user of the terminal 11 and the like. Also, the server system 12 (the communication unit 122A of the host server 122) can transmit the passing certificate as image data to any photo album device A2 designated by the user of the terminal 11 through the boundary line visualization application in the same way as other images.

The boundary line visualization application (the data reception unit 11T of the terminal 11) can acquire (receive) the digital data generated by the server system 12. The boundary line visualization application (the image storage unit 11H of the terminal 11) can save (store) the digital data received by the data reception unit 11T. The boundary line visualization application (the image display unit 11J of the terminal 11) can display the digital data received by the data reception unit 11T.

The digital data of the passing certificate kept in the server system 12 (the storage unit 122D of the host server 122) is delivered from the server system 12 to a home of the user of the digital photo album creation system A, a specialty store, or the like in response to a request of the user of the digital photo album creation system A so that a printing process of a printer of the home of the user of the digital photo album creation system A, a printing process of a printer of the specialty store, or the like is performed.

For example, when the printing process is performed by the printer of the specialty store, a reference number required for downloading the digital data of the passing certificate kept in the server system 12 or the like is issued from the server system 12 to the specialty store or the like. When a staff member of the specialty store accesses the server system 12 and enters the issued reference number, the digital data of the passing certificate is downloaded from the server system 12 to the specialty store and the passing certificate is printed by the printer of the specialty store.

In the boundary line visualization system 1 of the first embodiment, the boundary line BL (for example, the International Date Line) incapable of being seen in reality can be shown by augmented reality (AR) as if the boundary line BL is actually present. For example, in the case of the example of the above-mentioned aircraft, it is possible to implement an announcement within the aircraft such as “The red line visible under the window is the International Date Line.” That is, the boundary line visualization system 1 of the first embodiment can provide a highly entertaining travel experience.

Although the terminal 11 passes through the boundary line BL (the International Date Line) using the aircraft in the above-described example, the terminal 11 may pass the boundary line BL (the International Date Line, the IERS Reference Meridian, the equator, the national border, or the like) using public transportation other than aircraft such as ships, railroads, and buses, private vehicles, and the like in other examples.

Also, when the boundary line visualization system 1 of the first embodiment is used in a room surrounded by glass, a wall, or the like that blocks radio waves, it may be possible to acquire the location of an aircraft, a ship, or the like by replacing the terminal state acquisition unit 11F with a GPS receiver through an Internet network. In this case, it is possible to prevent deterioration in the accuracy of the location due to the poor reception of radio waves.

Although the image is displayed on the display 11A of the terminal 11 in the above-described example, the image of the boundary line BL may be projected onto the window glass by a projector installed near the window so that the window glass is used as a display medium in another example. In this case, because the image of the boundary line BL appears to overlap the scenery seen through the window, an effect equivalent to that of the above-described example can be obtained without the user retaining the terminal 11 or the like in his/her hand. Also, in this case, the projector used in place of the terminal 11 may be configured to have a means for acquiring information such as a location and an attitude as in the terminal 11 or acquire information such as a location or an attitude from a flight system provided in an aircraft or the like through a means such as wireless communication. Further, the above-mentioned projector may be configured to have a means for recognizing a location of the users line of sight or the users head, and, in this case, it is possible to optimize a location of projection of the image of the boundary line BL onto the window glass in accordance with a locational relationship between the user and the window.

Also, a transmissive display device may be provided instead of the window glass and the transmissive display device may be used as the display 11A. In this case, the terminal 11 may be a stationary terminal instead of a portable terminal.

Also, the terminal 11 may be a wearable terminal such as a smartwatch or smart glasses. In this case, for example, as an example of an eyeglass-type, goggle-type, or contact-lens-type wearable terminal, the display 11A including a liquid crystal display device or a retinal scanning laser display device can be mentioned.

Also, the server system 12 may be configured to have the printer 123 connected to the satellite server 121 within the aircraft. In this case, the satellite server 121 connected to the printer 123 automatically extracts a composite image CM including tag information indicating that the International Date Line is included in the image transmitted from the terminal 11 to the satellite server 121.

The printer 123 can print the composite image CM extracted by the satellite server 121 on prescribed paper. The printer 123 can print a composite image CM including a date and time when the terminal 11 passed the International Date Line, a flight number of an aircraft, a name of a captain (a signature of the captain) of the aircraft, and the like on the paper.

If necessary, when user information of the digital photo album creation system A associated with the boundary line visualization application matches flight ticket information of the aircraft, the printer 123 may print a composite image CM including personal information such as the users personal name as a passing certificate on the paper. Thereby, it is possible to create a passing certificate within the aircraft and present the passing certificate to the user.

### Second Embodiment

Hereinafter, a second embodiment of a boundary line visualization system, a boundary line visualization method, and a boundary line visualization program of the present invention will be described.

A boundary line visualization system 1 of the second embodiment is configured like the boundary line visualization system 1 of the first embodiment described above, except for differences to be described below. Accordingly, according to the boundary line visualization system 1 of the second embodiment, effects similar to those of the boundary line visualization system 1 of the first embodiment described above can be obtained except for differences to be described below.

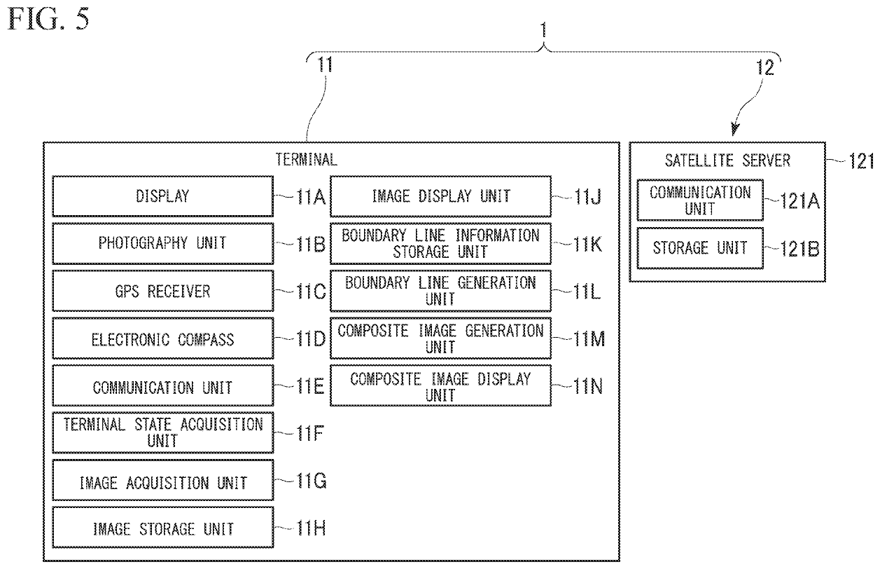

FIG. 5 is a diagram showing an example of an overview of the boundary line visualization system 1 of the second embodiment.

The boundary line visualization system 1 of the second embodiment is, for example, a system that visualizes a boundary line in land registration or the like. As will be described below, in the boundary line visualization system 1 of the second embodiment, when the boundary line is unclear, for example, in a mountain forest or the like, it is possible to ascertain an outline of what is one's own land and what is another's land. Although the accuracy of display varies with the accuracy of information provided by GFS satellites, the boundary line can be visualized with sufficient accuracy for practical use because location information with an error of several centimeters could be acquired in recent years.

In the example shown in FIG. 5, the boundary line visualization system 1 includes a terminal 11 and a server system 12.

The terminal 11 is, for example, a portable phone, a smartphone a tablet terminal, or the like. The terminal 11 includes, for example, a display 11A, a photography unit 11B, a GPS receiver 11C, an electronic compass 11D, and a communication unit 11E as hardware.

The terminal 11 includes a boundary line visualization application that operates on hardware.

As the boundary line visualization application, the terminal 11 includes a terminal state acquisition unit 11F, an image acquisition unit 11G, an image storage unit 11H, an image display unit 11J, a boundary line information storage unit 11K, a boundary line generation unit 11L, a composite image generation unit 11M, and a composite image display unit 11N.

The terminal state acquisition unit 11F acquires a state of the terminal 11 including coordinates and an attitude of the terminal 11.

The image acquisition unit 11G acquires an image IM (for example, a still image or a moving image including a prescribed location. The image acquisition unit 11G acquires, for example, the image IM including scenery captured by the photography unit 11B. The image acquisition unit 11G can also acquire the image IM delivered by, for example, the server system 12.

The boundary line information storage unit 11K stores information about a boundary line BL, which is a target of visualization by the boundary line visualization system 1 of the second embodiment. The boundary line information storage unit 11K stores information about coordinates such as, for example, latitude and longitude indicating the boundary line BL. In the boundary line visualization system 1 of the second embodiment, the boundary line information storage unit 11K stores, for example, information about coordinates indicating a boundary in land registration, a prefectural border, a national border, a contour line of territorial waters, a contour line of an exclusive economic zone, or the like as information about the boundary line BL.

The boundary line generation unit 11L generates a CG image based on coordinates of the boundary line BL present within a certain range from the terminal 11 (for example, a boundary in land registration, a prefectural border, a national border, a contour line of territorial waters, a contour line of an exclusive economic zone, or the like) on the basis of the state of the terminal 11 acquired by the terminal state acquisition unit 11F.

The composite image generation unit 11M generates a composite image CM in which the CG image of the boundary line BL is superimposed on the image IM on the basis of coordinates indicating the prescribed location included in the image IM acquired by the image acquisition unit 11G and coordinates indicating the boundary line BL.

The server system 12 includes a communication unit 12A and a database 12B.

The communication unit 12A performs communication with the terminal 11 and the like. The database 12B stores location information for identifying the boundary line BL based on land registration information and the like.

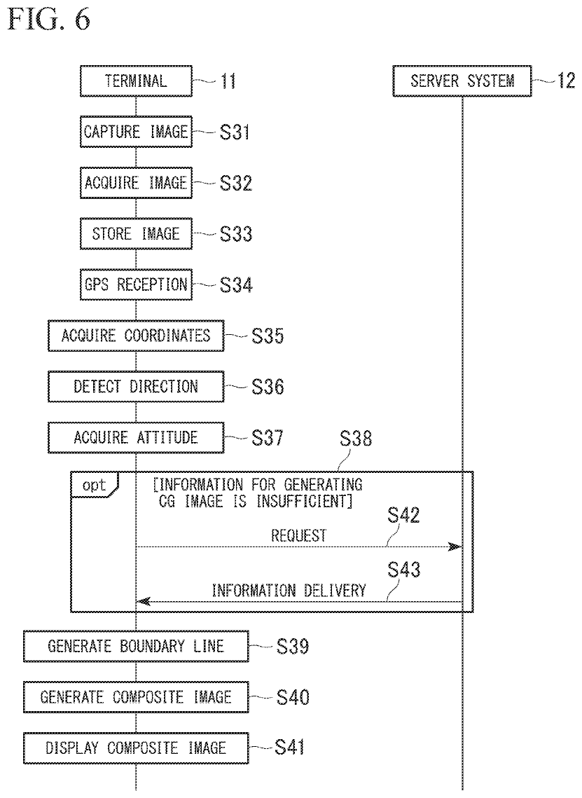

FIG. 6 is a sequence diagram for describing an example of a process executed in the boundary line visualization system 1 of the second embodiment.

In the example shown in FIG. 6, in step S31, the photography unit 11B of the terminal 11 captures an image IM including scenery. The image IM including the scenery includes a prescribed location and coordinates indicating the prescribed location are recognized in advance by the terminal 11.

Subsequently, in step S32, the image acquisition unit 11G of the terminal acquires the image IM including the scenery captured in step S31.

Subsequently, in step S33, the image storage unit 11H of the terminal 11 stores the image IM including the scenery acquired in step S32.

Also, in step S34, the GPS receiver 11C of the terminal 11 receives radio waves from the GPS satellites.

Subsequently, in step S35, the terminal state acquisition unit 11F of the terminal 11 calculates coordinates of the terminal 11 on the basis of radio waves received in step S34 and acquires the calculated coordinates of the terminal 11 as the state of the terminal 11.

Also, in step S36, the electronic compass 11D of the terminal 11 detects a direction (a direction of the terminal 11) by observing geomagnetism or the like.

Subsequently, in step S37, the terminal state acquisition unit 11F of the terminal 11 calculates an attitude of the terminal 11 on the basis of the direction of the terminal 11 detected in step S36 or the like and acquires the calculated attitude of the terminal 11 as the state of the terminal 11.

Subsequently, in step S38, for example, the boundary line generation unit 11L of the terminal 11 determines whether it is possible to generate a CG image of a boundary line BL (for example, a boundary in land registration, a prefectural border, a national border, a contour line of territorial waters, a contour line of an exclusive economic zone, or the like) present within a certain range from the terminal 11 on the basis of the state of the terminal 11 acquired in steps S35 and S37 and information necessary for generating the CG image of the boundary line BL stored in the boundary line information storage unit 11K. if the boundary line generation unit 11L can generate a CG image of the boundary line BL, the process proceeds to step S39. On the other hand, when the boundary line generation unit 11L cannot generate the CG image of the boundary line BL (for example, when the information for generating the CG image is insufficient), the process proceeds to step S42.

In step S39, the boundary line generation unit 11L of the terminal 11 generates a CG image of a boundary line BL (for example, a boundary in land registration, a prefectural border, a national border, a contour line of territorial waters, a contour line of an exclusive economic zone, or the like) present within a certain range from the terminal 11 on the basis of the state of the terminal 11 acquired in steps S35 and S37 and information necessary for generating the CG image of the boundary line BL stored in the boundary line information storage unit 11K.

Subsequently, in step S40, the composite image generation unit 11M of the terminal 11 generates a composite image CM in which the CG image of the boundary line BL is superimposed on the image IM on the basis of the coordinates indicating a prescribed location included in the image IM including the scenery acquired in step S32 and the coordinates indicating the boundary line BL stored in the boundary line information storage unit 11K of the terminal 11.

Subsequently, in step S41, the composite image display unit 11N of the terminal 11 displays the composite image CM generated in step S39.

In step S38 described above, because the information necessary for the boundary line generation unit 11L to generate the CG image of the boundary line BL is not stored in the boundary line information storage unit 11K, when the boundary line generation unit 11L cannot generate a CG image of the boundary line BL, the communication unit 11E of the terminal 11 requests the server system 12 to provide information necessary for generating the CG image of the boundary line BL in step S42.

Subsequently, in step S43, the communication unit 12A of the server system 12 transmits the information necessary for generating the CG image of the boundary line BL stored in the database 12B of the server system 12 to the terminal 11.

Subsequently, in step S39, the boundary line generation unit 11L of the terminal 11 generates the CG image of the boundary line BL present within a certain range from the terminal 11 on the basis of the state of the terminal 11 acquired in steps S35 and S37 and the information necessary for generating the CG image of the boundary line BL transmitted from the server system 12 in step S43.

In step S43 described above, when the information necessary for generating the CG image of the boundary line BL is not stored in the database 12B of the server system 12, the server system 12 accesses an external organization (not shown) such as a map information database with coordinates created on the basis of, for example, a land register and land registration information, and acquires the information necessary for generating the CG image of the boundary line BL.

Subsequently, the communication unit 12A of the server system 12 transmits the information necessary for generating the CG image of the boundary line BL acquired from the external organization to the terminal 11.

Subsequently, in step S39, the boundary line generation unit 11L of the terminal 11 generates the CG image of the boundary line BL present within the certain range from the terminal 11 on the basis of the state of the terminal 11 acquired in steps S35 and S37 and the information necessary for generating the CG image of the boundary line BL transmitted from the server system 12 (the information acquired from the external organization).

As described above, the boundary line visualization system 1 of the second embodiment includes the boundary line visualization application installed in the terminal 11 having a communication function and the server system 12 capable of communicating with the terminal 11.

When the photography unit 11B captures an image IM (a moving image or a still image) while the boundary line visualization application is being activated, the image acquisition unit 11G acquires the image IM (the moving image or the still image) captured by the photography unit 11B. The image display unit 11J can perform a preview display process on the image IM (the moving image or the still image) acquired by the image acquisition unit 11G.

In an example of the boundary line visualization system 1 of the second embodiment, when the user of the terminal 11 wants to ascertain information about the boundary line BL within a range in which photography is performed by the photography unit 11B of the terminal 11, the communication unit 11E of the terminal 11 requests the server system 12 to provide the information about the boundary line BL. Specifically, the communication unit 11E of the terminal 11 transmits coordinates (a current location) of the terminal 11 calculated on the basis of radio waves from the GPS satellites to the server system 12.

When the current location of the terminal 11 is received, the server system 12 transmits information about the boundary line BL present within the certain range from the current location of the terminal 11 (information such as location information necessary for generating the CG image of the boundary line BL) stored in the database 12B to the terminal 11.

The boundary line generation unit 11L of the terminal 11 generates a CG image of the boundary line BL in correspondence with a location and an attitude of the terminal 11 using the coordinates of the terminal 11 (latitude, longitude, and altitude of the terminal 11 calculated on the basis of radio waves from the GPS satellites), the information about the boundary line BL transmitted from the server system 12, and the like.

The composite image generation unit 11M of the terminal 11 generates a composite image CM in which the CG image of the boundary line BL generated by the boundary line generation unit 11L is superimposed on the image IM acquired by the image acquisition unit 11G.

The composite image display unit 11N of the terminal 11 displays the composite image CM generated by the composite image generation unit 11M (for example, preview display).

The terminal 11 can also save a composite image CM (a moving image or a still image) in which the CG image of the boundary line BL is superimposed on an actual landscape image (an image IM including scenery), if necessary.

Thereby, the user of the terminal 11 can ascertain the location of the boundary line BL.

In the boundary line visualization system 1 of the second embodiment, a line that cannot be seen in reality (a boundary line BL in land registration) can be shown by augmented reality (AR) as if the line is present actually. The boundary line visualization system 1 of the second embodiment is available as a tool for resolving a minor dispute that does not require a survey to confirm a boundary line BL (an unclear boundary line) between one's own land and another's land.

Also, in the boundary line visualization system 1 of the second embodiment, even if a boundary marker indicating a boundary line BL (an invisible line) moves due to a landslide or the like, the boundary line BL can be ascertained by AR with an error of several centimeters. Thus, it is possible to ascertain a boundary line BL with a certain high degree of accuracy before an expert or a country creates a boundary determination map.

Also, the boundary line visualization system 1 of the second embodiment can show a boundary line in an easy-to-understand manner in the case where a structure of another person is clearly built over the own land, the case where there is a risk that an aircraft, a ship, or the like will illegally enter an exclusive economic zone or territorial waters of another country, and the like.

### Third Embodiment

Hereinafter, a third embodiment of a boundary line visualization system, a boundary line visualization method, a boundary line visualization program, and a digital photo album creation system of the present invention will be described.

A boundary line visualization system 1 of the third embodiment is configured like the boundary line visualization system 1 of the first embodiment described above, except for differences to be described below. Accordingly, according to the boundary line visualization system 1 of the third embodiment, effects similar to those of the boundary line visualization system 1 of the first embodiment described above can be obtained except for differences to be described below.

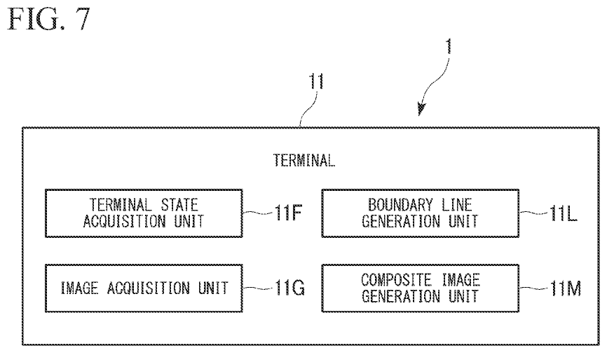

FIG. 7 is a diagram showing an example of an overview of the boundary line visualization system 1 of the third embodiment.

In the example shown in FIG. 7, the boundary line visualization system 1 includes a terminal 11.

The terminal 11 includes a terminal state acquisition unit 11F, an image acquisition unit 11G, a boundary line generation unit 11L, and a composite image generation unit 11M.

The terminal state acquisition unit 11F acquires a state of the terminal 11 including coordinates and an attitude of the terminal 11.

The image acquisition unit 11G acquires an image IM including a prescribed location.

The boundary line generation unit 11L retains a database including a name, a type, coordinates, and the like of the boundary line BL and generates a CG image based on coordinates of the boundary line BL present within a certain range from the terminal 11 on the basis of the state of the terminal 11 acquired by the terminal state acquisition unit 11F using the database.

The composite image generation unit 11M generates a composite image CM in which the CG image of the boundary line BL is superimposed on the image IM on the basis of the coordinates indicating the prescribed location included in the image IM acquired by the image acquisition unit 11G and the coordinates indicating the boundary line BL.

### Fourth Embodiment

Hereinafter, a fourth embodiment of a boundary line visualization system, a boundary line visualization method, and a boundary line visualization program of the present invention will be described. A boundary line visualization system 1 of the fourth embodiment is configured like the boundary line visualization systems 1 of the first embodiment and the second embodiment described above, except for differences to be described below Accordingly, according to the boundary line visualization system 1 of the fourth embodiment, effects similar to those of the boundary line visualization systems 1 of the first embodiment and the second embodiment described above can be obtained except for differences to be described below.

The boundary line visualization system 1 of the fourth embodiment is a system for visualizing a boundary line and displaying information associated with one or more regions from which a region where a terminal 11 is present is excluded within two or more regions obtained in a division process using the boundary line (hereinafter, the information is referred to as “region-related information”) together with a CG image of the boundary line on the terminal 11.

A boundary line information storage unit 11K of the boundary line visualization system 1 of the fourth embodiment can acquire and store, for example, information about coordinates indicating the International Date Line, the Greenwich Meridian, the IERS Reference Meridian, the equator, a boundary in land registration, a prefectural border, a national border, a contour line of territorial waters, a contour line of an exclusive economic zone, coastlines (high tide and low tide coastlines may be distinguished), a contour line (a line indicating a sea level and elevation and a line indicating a certain height of a mountain), a line indicating a boundary of a risk level in a hazard map, a line taken along a road such as a sidewalk or a roadway, or another boundary line for logically dividing any region on the ground surface or the sea surface, or the like, as information about the boundary line BL.

A configuration in which information about the boundary line BL may be stored in advance in the boundary line information storage unit 11K or information about the boundary line BL within a certain range centered on the terminal 11 on the basis of the location of the terminal 11 is appropriately provided from the server system 12 through an Internet network or the like may be adopted.

Original information for the region-related information is saved in the server system 12 and is generated as the region-related information on the basis of the location information of the terminal 11. The region-related information includes fixed information such as geographical information (a country name, a prefecture name, and the like) and detailed information (a historical background, a tourist attraction, a disaster risk, and the like) about an associated region, dynamic information such as advertisements related to the associated region, announcements of events and entertainments to be carried out in the region and warnings and alerts related to the associated region, and the like. The dynamic information includes information indicating a validity period of information.

The region-related information includes text data, image data, audio data, video data, programs, and the like.

An example of the application of the boundary line visualization system 1 of the fourth embodiment will be described. In the boundary line visualization system 1 of the fourth embodiment, in a process of retaining and moving the terminal 11 with respect to the user who owns the terminal 11, the region-related information is displayed on the display 11A of the terminal 11 at a timing when the terminal 11 has approached the boundary line BL or has crossed the boundary line BL.

Specifically, after the boundary line visualization application installed in the terminal 11 acquires the attitude of the terminal 11 (see step S37 of FIG. 6), the server system 12 is notified of the location of the terminal 11 as a part of a request for information for CG image generation (see step S42 of FIG. 6). The server system 12 transmits the region-related information to the terminal 11 on the basis of the location of the terminal 11 and the current timepoint (see step S43 of FIG. 6). At this time, the server system 12 transmits the region-related information associated with a region where the terminal 11 is not included within two regions obtained in a division process using the boundary line BL on the basis of the location of the terminal 11 to the terminal 11. Thereby, the terminal 11 can acquire region-related information associated with a region where the user retaining the terminal 11 is about to enter or a region adjacent to a region where the user retaining the terminal 11 is located. The boundary line visualization application of the terminal 11 that has acquired the region-related information generates a CG image of the boundary line BL (see step S39 of FIG. 6) and also generates a composite image CM or other playable content based on the region-related information (step S40 of FIG. 6). The playable content is content suitable for providing information, advertisements, notifications of events, and the like for users.

The boundary line visualization application causes the playable content generated in the above-described step S40 to be displayed on the display 11A of the terminal 11 (see step S41 of FIG. 6). Also, the boundary line visualization application outputs playable content using available functions of the terminal 11 such as, for example, audio playback or vibrations, when the playable content has information other than the visual information.

The boundary line visualization system 1 of the fourth embodiment can provide the user with information, advertisements, and the like related to a region beyond the crossing of a boundary line in accordance with the proximity of the user retaining the terminal 11 to the boundary line or an event of the crossing of the boundary line on the basis of the location of the terminal 11. Thereby, according to the boundary line visualization system of the fourth embodiment, the user can receive information and advertisements closely related to the users behavior and the like, so that the users satisfaction can be enhanced.

Also, when the advertisement is delivered using the boundary line visualization system 1 of the fourth embodiment, the advertisement closely related to the users behavior is selected and delivered to the terminal 11, so that the effect of advertising can be enhanced and it is possible to easily measure and analyze the relationship between the users behavior and the effect of advertising.

Also, when an alarm or alert is delivered using the boundary line visualization system 1 of the fourth embodiment, the alarm or alert closely related to the users behavior is selected and delivered to the terminal 11, so that it is possible to prevent inadvertent entry into dangerous regions during a period when warnings and alerts are issued.

Although modes for carrying out the present invention have been described using embodiments, the present invention is not limited to the embodiments and various modifications and substitutions can also be made without departing from the scope and spirit of the present invention. The configurations described in the above-described embodiments and examples may be combined.

In the boundary line visualization system 1 of each of the above-described embodiments, it is possible to allow the user to visually recognize the boundary line that cannot he visually recognized in reality using the augmented reality (AR) in an example in which a CG image of the International Date Line, the Greenwich Meridian, the IERS Reference Meridian, the equator, a prefectural border, a national border, a contour line, or the like is generated as the CG image of the boundary line BL. Thereby, in the boundary line visualization system 1 of each embodiment, it is possible to notify a user of a process in which the user moves toward the boundary line BL and crosses the boundary line more intuitively than in the conventional technology for providing a notification of the crossing of the boundary line using text information, a sound, or the like. Also, according to the boundary line visualization system 1 of each embodiment, the boundary line BL can be visualized using augmented reality (AR), so that a process of crossing the boundary line in front of the eyes is visually recognized and it can provide users with extraordinary experiences. Because it is possible to give an opportunity to prompt the user to move beyond the boundary line, such a boundary line visualization system 1 can be used as a tool for enhancing the excitement (the pleasure of traveling) of the user in the fields of travel such as overseas travel, domestic travel, cruising, and mountain climbing.

Also, in the boundary line visualization system 1 of each of the above-described embodiments, a CG image of an area where an in-game event is generated in a location-based game can be generated as an example of a CG image of the boundary line BL for logically dividing any region. In this case, in the boundary line visualization system 1 of each embodiment, a complicated shape surrounded by a line instead of a point on the earth determined by one coordinate or a circular area centered on this point can be designated as an event generation area. Thereby, it is possible to increase a degree of freedom of expression in the location-based game. Also, because it is possible to set a boundary line that matches the shape of a facility that is present actually or the like and allow the user to recognize the event generation area using augmented reality (AR), it is possible to produce a close connection between reality and the game.

Also, in the boundary line visualization system 1 of each of the above-described embodiments, for example, in an example in which a CG image of a boundary in land registration, a territorial contour line, a contour line of territorial waters, a line indicating a boundary of a risk level in a hazard map, or the like is generated as a CG image of the boundary line BL, it is possible to avoid ambiguity and achieve dispute resolution by allowing the user to visually recognize a boundary line that cannot be visually recognized in reality using augmented reality (AR). Also, it is possible to present an evacuation site having a lower risk level at the time of a disaster more intuitively than in a general map display application by allowing the user to recognize the line indicating the boundary of the risk level in the hazard map by superimposing the line on an actual landscape using augmented reality (AR).

Also, all or some of the functions of the parts provided in the boundary line visualization system 1 and the digital photo album creation system A according to the above-described embodiment may be implemented by recording a program for implementing the functions on a computer-readable recording medium and causing a computer system to read and execute the program recorded on the recording medium. Also, the “computer system” described here is assumed to include software such as an operating system (OS) and hardware such as peripheral devices.

Also, the “computer-readable recording medium” refers to a flexible disk, a magneto-optical disc, a ROM, a portable medium such as a CD-ROM, a DVD-ROM, or a flash memory, a storage unit such as a hard disk embedded in the computer system, or a solid-state disk. Further, the “computer-readable recording medium” may include a computer-readable recording medium for dynamically retaining the program for a short time period as in a communication line when the program is transmitted via a network such as the Internet or a communication circuit such as a telephone circuit and a computer-readable recording medium for retaining the program for a given time period as in a volatile memory inside the computer system serving as a server or a client when the program is transmitted. Also, the above-described program may be a program for implementing some of the above-described functions. Further, the above-described program may be a program capable of implementing the above-described function in combination with a program already recorded on the computer system.

### REFERENCE SIGNS LIST

1 Boundary line visualization system

11 Terminal

11A Display

11B Photography unit

11C GPS receiver

11D Electronic compass

11E Communication unit

11R Terminal state acquisition unit

11G Image acquisition unit

11H image storage unit

11I Window frame identification unit

11J Image display unit

11K Boundary line information storage unit

11L Boundary line generation unit

11M Composite image generation unit

11N Composite image display unit

11P Boundary line passing timepoint estimation unit

11Q Text information addition unit

11R Tag information assignment unit

11S Image transmission unit

11T Data reception unit

11U Certificate display unit

12 Server system

121 Satellite server

121A Communication unit

121B Storage unit

122 Host server

122A Communication unit

122B Image extraction unit

122C Data generation unit

122D Storage unit

123 Printer

12A Communication unit

12B Database

A Digital photo album creation system

A1 Album application

A2 Photo album device

1. A boundary line visualization system having a terminal, the boundary line visualization system comprising:
an image acquisition unit configured to acquire an image including a prescribed location;
a terminal state acquisition unit configured to acquire a state of the terminal including coordinates and an attitude of the terminal;
a boundary line generation unit configured to generate a computer graphics (CG) image based on coordinates of a boundary line present within a certain range from the terminal on the basis of the state of the terminal acquired by the terminal state acquisition unit; and
a composite image generation unit configured to generate a composite image in which the CG image of the boundary line is superimposed on the image on the basis of the coordinates indicating the boundary line and the coordinates indicating the prescribed location included in the image acquired by the image acquisition unit.

2. The boundary line visualization system according to claim 1,
wherein the image acquisition unit acquires an image including scenery photographed by the terminal as the image, and
wherein the composite image generation unit generates a composite image in which the image of the boundary line is superimposed on the image including the scenery photographed by the terminal.

3. The boundary line visualization system according to claim 1,
wherein the image acquisition unit acquires an image including outside scenery photographed by the terminal from inside of a room having a window through the window as the image,
wherein the boundary line generation unit generates a CG image in which a part present within the certain range from the terminal within the boundary line is set as a display target as the CG image of the boundary line, and
wherein the composite image generation unit generates a composite image in which the CG image of the boundary line is superimposed on the image including the outside scenery photographed by the terminal.

4. The boundary line visualization system according to claim 3, wherein the composite image generation unit causes the CG image of the boundary line to be superimposed on the image so that the CG image of the boundary line is thinner when the boundary line is farther from the terminal and disappears on the horizon.

5. The boundary line visualization system according to claim 3, comprising a window frame identification unit configured to identify a window frame included in the image acquired by the image acquisition unit,
wherein the composite image generation unit causes the CG image of the boundary line to be superimposed on the image so that the CG image of the boundary line is located inside the window frame identified by the window frame identification unit.

6. The boundary line visualization system according to claim 1, comprising:
a boundary line passing timepoint estimation unit configured to estimate a timepoint at which the terminal will pass the boundary line on the basis of the coordinates of the terminal acquired by the terminal state acquisition unit and the coordinates indicating the boundary line; and
a text information addition unit configured to add text information indicating the timepoint at which the terminal will pass the boundary line estimated by the boundary line passing timepoint estimation unit to the composite image generated by the composite information generation unit.

7. The boundary line visualization system according to claim 1, comprising:
a tag information assignment unit configured to assign tag information indicating that the boundary line is included in the composite image generated by the composite image generation unit to data of the composite image; and
a data generation unit configured to generate passing certificate data for certifying that the terminal has passed the boundary line on the basis of the tag information assigned to the data of the composite image.

8. The boundary line visualization system according to claim 1, wherein the boundary line is the International Date Line.

9. The boundary line visualization system according to claim 1, wherein the boundary line is a line for dividing a ground surface into a plurality of regions in correspondence with a disaster risk level.

10. A boundary line visualization method comprising:
an image acquisition step of acquiring an image including a prescribed location;
a terminal state acquisition step of acquiring a state of a terminal including coordinates and an attitude of the terminal;
a boundary line generation step of generating a CG image based on coordinates of a boundary line present within a certain range from the terminal on the basis of the state of the terminal acquired in the terminal state acquisition step; and
a composite image generation step of generating a composite image in which the CG image of the boundary line is superimposed on the image on the basis of the coordinates indicating the boundary line and the coordinates indicating the prescribed location included in the image acquired in the image acquisition step.

11. A boundary line visualization program for causing a computer to execute:
an image acquisition step of acquiring an image including a prescribed location;
a terminal state acquisition step of acquiring a state of a terminal including coordinates and an attitude of the terminal;
a boundary line generation step of generating a CG image based on coordinates of a boundary line present within a certain range from the terminal on the basis of the state of the terminal acquired in the terminal state acquisition step; and
a composite image generation step of generating a composite image in which the CG image of the boundary line is superimposed on the image on the basis of the coordinates indicating the boundary line and the coordinates indicating the prescribed location included in the image acquired in the image acquisition step.

12. A digital photo album creation system having a terminal, the digital photo album creation system comprising:
an image acquisition unit configured to acquire an image including a prescribed location;
a terminal state acquisition unit configured to acquire a state of the terminal including coordinates and an attitude of the terminal;
a boundary line generation unit configured to generate a CG image based on coordinates of a boundary line present within a certain range from the terminal on the basis of the state of the terminal acquired by the terminal state acquisition unit; and
a composite image generation unit configured to generate a composite image in which the CG image of the boundary line is superimposed on the image on the basis of the coordinates indicating the boundary line and the coordinates indicating the prescribed location included in the image acquired by the image acquisition unit.
